(19) United States
(12) Patent Application Publication
(10) Pub. No.: US 2012/0166045 A1
(43) Pub. Date: Jun. 28, 2012

(54) COMBINED ABS/AIRBAG CONTROL UNIT

(76) Inventors: Matthias Marcus WELLHOEFER, Stuttgart (DE); Stefan NORDBRUCH, Kornwestheim (DE); Johannes GEIGER, Stuttgart (DE); Martin KRETZSCHMAR, Campinas/Sp (BR); Christian MOTZ, Ludwingsburg (DE)

(21) Appl. No.: 13/302,687

(22) Filed: Nov. 22, 2011

(30) Foreign Application Priority Data
Nov. 30, 2010 (DE) 102010062210.9

(51) Int. Cl. B60R 21/16

(52) U.S. Cl. 701/45

(57) ABSTRACT

A control unit has an ABS control algorithm. For use on motorcycles, it is advantageous if the control unit also includes an airbag algorithm for actuating an airbag, a maximum of two but preferably only a single acceleration sensor for detecting a collision, and a maximum of two but preferably only a single ignition stage which generates a signal for igniting an airbag when a collision is detected.

### FIELD OF THE INVENTION

The present invention relates to a control unit for an ABS system (ABS: antilock braking system) which has an associated control algorithm and is designed, in particular, for use on motorcycles.

### BACKGROUND INFORMATION

Modern automobiles and motorcycles are usually equipped with ABS and airbag systems for protecting the passengers. Each system usually includes multiple components, each of which is used exclusively by this system. For example, an ABS system includes an associated ABS control unit which has an ABS control algorithm, sensors for determining the wheel slip, and various actuators for regulating the wheel slip. A known airbag system, on the other hand, includes an associated airbag control unit, multiple crash sensors for detecting a collision, and at least one ignition stage for triggering an airbag. The ignition stages are integrated circuits which transmit an activation signal to the airbag's triggering mechanism after a collision. The separate configuration of the two systems is unsuitable, In particular, for use on motorcycles, since this configuration is relatively complex and occupies a great deal of space.

### SUMMARY OF THE INVENTION

An object of the present invention is therefore to reduce the complexity and space requirements of an ABS system and an airbag system, in particular for use on motorcycles.

According to the present invention, it is provided to integrate the most important functionalities of an ABS system and an airbag system into a single, shared control unit. According to the present invention, a combined ABS/airbag control unit of this type includes at least one ABS control algorithm, one airbag algorithm for actuating an airbag, at least one acceleration sensor for detecting a collision, and at least one ignition stage which generates a signal for triggering an airbag when a collision is detected. All of the aforementioned components are preferably accommodated in the housing of a single combined ABS/airbag control unit. In this way, both systems may be implemented by minimizing the wiring complexity and space requirements.

According to a preferred specific embodiment of the present invention, the combined ABS/airbag control unit includes a maximum of two but preferably only a single acceleration sensor. In addition, a maximum of two but preferably only a single ignition stage may be provided. This makes it possible to further reduce the complexity of the system.

If the combined ABS/airbag control unit includes two acceleration sensors, one of the sensors is preferably used to measure a longitudinal acceleration of the vehicle, and the other sensor is used to measure the transverse acceleration.

The one or more acceleration sensors and the ignition stage(s) are preferably situated together on a single chip (ASIC). The wiring complexity may also be reduced in this way.

If the combined ABS/airbag control unit includes multiple ignition stages, these ignition stages may be provided for a single airbag or for multiple airbags.

The installation space may be further reduced if the ABS/airbag control unit according to the present invention does not have an additional energy storage. Known ABS or airbag control units are usually supplied with electrical power from the vehicle battery. In the event that the battery terminal is disconnected during a collision, a buffer storage is customarily provided as a power reserve which continues to supply power to important circuits or certain sensors after the power failure for a certain period of time, for example for 200 ms to 300 ms after the power failure. An electrical energy storage of this type may be omitted in the ABS/airbag control unit according to the present invention, which, in turn, saves space and costs.

The ABS/airbag control unit according to the present invention preferably includes an interface to at least one airbag. For example, this interface may be wirebound or a radio interface to a transmitter.

The airbag may be, for example, an airbag which is integrated into motorcycle gear.

The combined ABS/airbag control unit is designed, in particular, for use on motorcycles.

### BRIEF DESCRIPTION OF THE DRAWING

FIG. 1 shows a schematic representation of a combined ABS/airbag control unit according to a specific embodiment of the present invention.

### DETAILED DESCRIPTION

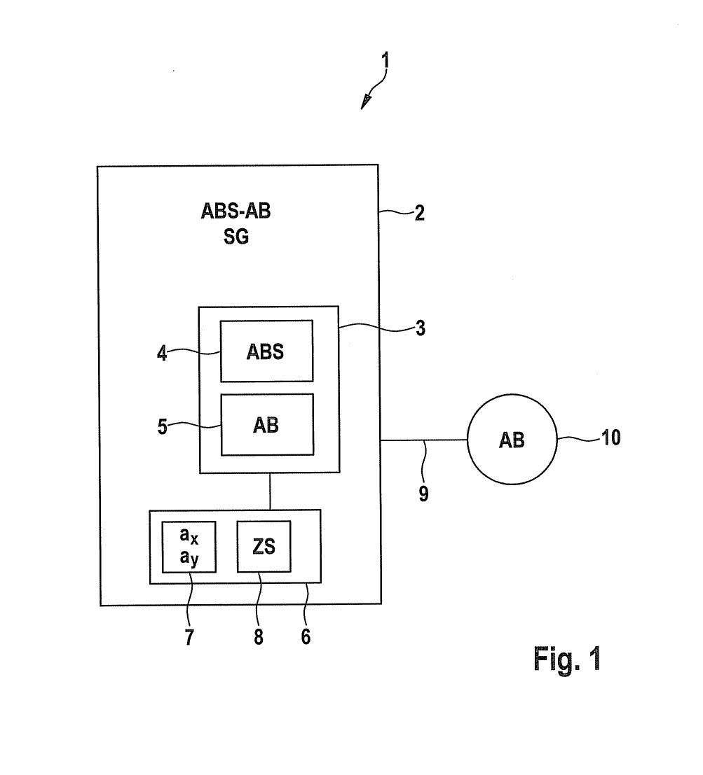

FIG. 1 shows a combined ABS/airbag control unit 1 which is designed, in particular, for use on motorcycles. Control unit 1 includes various components of both an ABS system and an airbag system which together are integrated into a control unit within a housing 2.

Of the components of the ABS system, only an ABS algorithm 4 is illustrated here, which is stored as software in a processor unit 3 of control unit 1. The associated ABS sensors, typically wheel rotational speed sensors, as well as the associated actuators of the ABS system, are not shown here.

With regard to the airbag system, control unit 1 includes an airbag algorithm 5 which evaluates the signals of associated airbag sensors 7 and, in the event that a collision is detected, activates an ignition stage 8 which transmits a corresponding ignition signal to an ignition device of airbag 10 over a data link 9. The data link may be, for example, a radio link.

Airbag sensors 7 and ignition stages 8 in this case are integrated on a shared chip 6 (ASIC). This substantially reduces the layout and, in particular, the wiring complexity within the airbag system.

In the illustrated exemplary embodiment, airbag sensors 7 include two acceleration sensors, of which one acceleration sensor measures accelerations in the longitudinal direction and the other acceleration sensor measures accelerations in the transverse direction of the vehicle. Optionally, only a single acceleration sensor could be provided, preferably for measuring longitudinal accelerations. The one or more acceleration sensors 7 may be designed, for example, to measure accelerations in the area of 100 g.

The number of ignition stages 8 is preferably no more than two. In the illustrated exemplary embodiment, only a single ignition stage 8 is provided. This makes it possible to further simplify the system.

Data link 9 may be wirebound or wireless. For airbags which are integrated into the clothing of a motorcycle rider, the ignition signal may be transmitted to the airbag, for example by radio. In this case, control unit 1 would include a corresponding transmitter.

What is claimed is:

1. A control unit comprising:
an ABS control algorithm;
an airbag algorithm for actuating an airbag;
at least one acceleration sensor; and
at least one ignition stage which generates a signal for triggering an airbag.

2. The control unit according to claim 1, wherein the at least one acceleration sensor and the at least one ignition stage are situated together on a chip.

3. The control unit according to claim 1, wherein a maximum of two acceleration sensors is provided, of which one acceleration sensor measures accelerations in a longitudinal direction and the other acceleration sensor measures accelerations in a transverse direction of a vehicle.

4. The control unit according to claim 1, wherein a maximum of two ignition stages is provided for one or multiple airbags.

5. The control unit according to claim 1, wherein no additional energy storage is provided in the control unit for temporary emergency power supply.

6. The control unit according to claim 1, wherein the control unit has a radio interface to an airbag.

7. The control unit according to claim 1, wherein the control unit is contained in a motorcycle.
